(19) United States
(12) Patent Application Publication
(10) Pub. No.: US 2013/0059209 A1
(43) Pub. Date: Mar. 7, 2013

(54) POSITIVE-ELECTRODE BODY FOR NONAQUEOUS-ELECTROLYTE BATTERY, METHOD FOR PRODUCING THE POSITIVE-ELECTRODE BODY, AND NONAQUEOUS-ELECTROLYTE BATTERY

(71) Applicants: Nobuhiro Ota, Itami-shi (JP); Mitsuyasu Ogawa, Itami-shi (JP); Ryoko Kanda, Itami-shi (JP)

(72) Inventors: Nobuhiro Ota, Itami-shi (JP); Mitsuyasu Ogawa, Itami-shi (JP); Ryoko Kanda, Itami-shi (JP)

(73) Assignee: SUMITOMO ELECTRIC INDUSTRIES, LTD., Osaka-shi (JP)

(21) Appl. No.: 13/698,150

(22) PCT Filed: May 7, 2011
(86) PCT No.: PCT/JP2011/060612

§ 371 Date: Nov. 15, 2012

(30) Foreign Application Priority Data
May 17, 2010 (JP) 2010-113702

(51) Int. Cl. H01M 10/0562; H01M 4/04; B82Y 30/00

(52) U.S. Cl. 429/304; 29/874; 977/755

(57) ABSTRACT

Provided is a positive-electrode body for a nonaqueous-electrolyte battery in which formation of high-resistance layers at the contact interfaces between positive-electrode active-material particles and solid-electrolyte particles is suppressed so that an increase in the interface resistance is suppressed. A positive-electrode body 1 for a nonaqueous-electrolyte battery according to the present invention includes a mixture of sulfide-solid-electrolyte particles 11 and covered positive-electrode active-material particles 10 in which surfaces of positive-electrode active-material particles 10a are covered with cover layers 10b having Li-ion conductivity. The cover layers 10b are formed of an amorphous oxide having oxygen deficiency. The cover layers 10b have oxygen deficiency and, as a result, Li-ion conductivity and electron conductivity that are sufficient for charge and discharge of the battery can be stably ensured in the cover layers 10b.

### TECHNICAL FIELD

The present invention relates to a positive-electrode body for a nonaqueous-electrolyte battery, the positive-electrode body being suitable for Li-ion secondary batteries and the like; a method for producing the positive-electrode body; and the nonaqueous-electrolyte battery.

### BACKGROUND ART

Nonaqueous-electrolyte batteries have been used as power supplies of relatively small electric devices such as portable devices. Such a nonaqueous-electrolyte battery includes a positive-electrode layer, a negative-electrode layer, and an electrolyte layer disposed between the electrode layers. A representative example of the nonaqueous-electrolyte battery is a Li-ion secondary battery, which is charged and discharged by exchange of Li ions between the positive-electrode layer and the negative-electrode layer through the electrolyte layer.

In recent years, a Li-ion secondary battery that is an all-solid-state Li-ion battery in which an organic electrolytic solution is not used for the conduction of Li ions between the positive-electrode layer and the negative-electrode layer has been proposed. The all-solid-state Li-ion battery employs a solid-electrolyte layer as the electrolyte layer and can overcome drawbacks caused by the use of organic-solvent electrolytic solution, for example, leak of the electrolytic solution. Such solid-electrolyte layers are formed of various sulfide-based substances that have high Li-ion conductivity and an excellent insulating property.

Compared with Li-ion batteries employing an organic electrolytic solution, all-solid-state Li-ion batteries employing a solid electrolyte have problems in that their capacity is low and output characteristics are poor. A possible cause of the problems is that, at the contact interface between the positive-electrode layer and the solid-electrolyte layer, interdiffusion occurs between these layers to form a high-resistance layer, resulting in an increase in the electric resistance (hereafter referred to as interface resistance). To address the problems, Patent Literature 1 discloses that 70% or more of the surfaces of positive-electrode active-material particles are covered with cover layers having Li-ion conductivity; it proposes a positive-electrode body prepared by mixing positive-electrode active-material particles covered with cover layers and sulfide-solid-electrolyte particles; positive-electrode active-material particles are covered with cover layers to suppress the formation of high-resistance layers at the contact interfaces between the positive-electrode active-material particles and the sulfide-solid-electrolyte particles, so that an increase in the interface resistance is suppressed to enhance the output characteristics of the Li-ion secondary battery. Patent Literature 2 discloses that cover layers having Li-ion conductivity and covering the surfaces of positive-electrode active-material particles contain conductive particles, so that the cover layers have electron conductivity.

### CITATION LIST

### Patent Literature

PTL 1: Japanese Unexamined Patent Application Publication No. 2009-193940
PTL 2: Japanese Unexamined Patent Application Publication No. 2003-59492

### SUMMARY OF INVENTION

### Technical Problem

However, as to the Li-ion secondary battery in PTL 1, when 70% or more and less than 100% of the surfaces of positive-electrode active-material particles are covered with cover layers, the positive-electrode active-material particles and the solid-electrolyte particles are partially in contact with each other. Accordingly, high-resistance layers are formed at the contact portions, resulting in an increase in the interface resistance. Alternatively, when the entire surfaces (100%) of positive-electrode active-material particles are covered with cover layers, since the cover layers do not have electron conductivity, continuity between positive-electrode active-material particles and current collection from positive-electrode active-material particles cannot be achieved; accordingly, the Li-ion secondary battery cannot function. On the other hand, in PTL 2, the cover layers contain conductive particles and, as a result, have electron conductivity. However, to ensure current collection sufficient for charge and discharge of the Li-ion secondary battery, conductive particles need to be in contact with each other, but there are cases where the contact between conductive particles is not achieved. In addition, there are problems that conductive particles fall off and the cover layers become separated because of a decrease in the strength of the cover layers.

The present invention has been accomplished under the above-described circumstances. An object of the present invention is to provide a positive-electrode body for a nonaqueous-electrolyte battery in which formation of high-resistance layers at the contact interfaces between positive-electrode active-material particles and solid-electrolyte particles is suppressed to suppress an increase in the interface resistance, so that Li-ion conductivity and electron conductivity that are sufficient for charge and discharge of the battery can be ensured with stability; a method for producing the positive-electrode body; and the nonaqueous-electrolyte battery.

### Solution to Problem

According to the present invention, cover layers covering the surfaces of positive-electrode active-material particles are made to have Li-ion conductivity and electron conductivity without additive particles of a conductive agent or the like. Thus, the object is achieved.

(1) A positive-electrode body for a nonaqueous-electrolyte battery according to the present invention relates to a positive-electrode body for a nonaqueous-electrolyte battery, the positive-electrode body including a mixture of sulfide-solid-electrolyte particles and covered positive-electrode active-material particles in which surfaces of positive-electrode active-material particles are covered with cover layers having Li-ion conductivity. The cover layers are formed of an amorphous oxide having oxygen deficiency.

In a positive-electrode body for a nonaqueous-electrolyte battery according to the present invention, cover layers have oxygen deficiency and, as a result, the cover layers themselves can have electron conductivity; even when the entire surfaces of the positive-electrode active-material particles are covered with the cover layers, current collection for the positive-electrode body sufficient for charge and discharge of the battery can be stably ensured. In addition, since the entire surfaces of the positive-electrode active-material particles can be covered with the cover layers, formation of high-resistance layers at the contact interfaces between the positive-electrode active-material particles and the solid-electrolyte particles is suppressed so that an increase in the interface resistance can be suppressed. As a result of covering the surfaces of the positive-electrode active-material particles with the cover layers, exchange of Li ions between the positive-electrode active-material particles and solid-electrolyte particles, exchange of electrons between the positive-electrode active-material particles, and current collection from the positive-electrode active-material particles can be stably achieved through the cover layers. In addition, to generate oxygen deficiency in the cover layers, a heat treatment described below is performed. When this heat treatment is performed at a high temperature, interdiffusion may occur between the cover layers and the positive-electrode active-material particles to form low-conductivity layers having a low Li-ion conductivity. Accordingly, to suppress the reaction between the cover layers and the positive-electrode active-material particles, the heat treatment needs to be performed at a low temperature and hence the cover layers are in the amorphous state. Since the cover layers are in the amorphous state, they can have a high Li-ion conductivity.

(2) In an embodiment of the present invention, the amorphous oxide contains Li and at least one element selected from Nb, Ta, and Ti.

Since the cover layers contain Li and at least one element selected from Nb, Ta, and Ti, the cover layers in the amorphous state can have a high Li-ion conductivity.

(3) In an embodiment of the present invention, degree α of the oxygen deficiency satisfies 0<α≦0.05.

The oxygen-deficiency degree α considerably influences Li-ion conductivity and electron conductivity. In the case of no oxygen deficiency (α=0), the cover layers are Li-ion conductors and substantially do not have electron conductivity. Cover layers having oxygen deficiency have electron conductivity. There is probably a tendency that an increase in the oxygen-deficiency degree α results in an increase in electron conductivity and a decrease in Li-ion conductivity. Since the cover layers are required to have electron conductivity, a needs to be more than 0. On the other hand, excessively large a probably results in a decrease in the Li-ion conductivity. Accordingly, when α is 0.05 or less, Li-ion conductivity and electron conductivity that are sufficient for charge and discharge of the battery can be ensured with stability.

(4) In an embodiment of the present invention, the cover layers have a thickness of 5 nm to 20 nm.

The thickness of the cover layers is preferably minimized as long as the formation of high-resistance layers at the contact interfaces between the positive-electrode active-material particles and the sulfide-solid-electrolyte particles can be suppressed. When the thickness of the cover layers is made 20 nm or less, the resistance of the cover layers themselves can be decreased. On the other hand, when the thickness of the cover layers is excessively small, the positive-electrode active-material particles tend to have portions that are not covered with the cover layers and, in these portions, high-resistance layers are formed, resulting in an increase in the interface resistance. When the thickness of the cover layers is made 5 nm or more, formation of high-resistance layers is suppressed so that an increase in the interface resistance can be suppressed.

(5) In an embodiment of the present invention, the covered positive-electrode active-material particles and the sulfide-solid-electrolyte particles are mixed in a weight ratio of 50:50 to 80:20.

A positive-electrode body for a nonaqueous-electrolyte battery according to the present invention includes a mixture of covered positive-electrode active-material particles and sulfide-solid-electrolyte particles. The sulfide-solid-electrolyte particles are necessary for mediating conduction of Li ions in the positive-electrode body. As to the mixing ratio, when the amount of the positive-electrode active-material particles is made less than the amount of the sulfide-solid-electrolyte particles, the amount of the positive-electrode active-material particles in the entirety of the positive-electrode body becomes small and the battery capacity decreases. On the other hand, when the amount of the positive-electrode active-material particles is made excessively large relative to the amount of the solid-electrolyte particles, conduction of Li ions in the positive-electrode body is less likely to be mediated. Accordingly, a preferred range of the mixing ratio of the covered positive-electrode active-material particles to the sulfide-solid-electrolyte particles is, in a weight ratio, 50:50 to 80:20.

(6) A method for producing a positive-electrode body for a nonaqueous-electrolyte battery according to the present invention includes the following steps:

(a) a covering step of covering surfaces of positive-electrode active-material particles with precursor cover layers having Li-ion conductivity;

(b) an oxygen-deficiency generation step of generating oxygen deficiency in the precursor cover layers to form cover layers; and

(c) a mixing step of mixing sulfide-solid-electrolyte particles and covered positive-electrode active-material particles having the cover layers.

In a method for producing a positive-electrode body for a nonaqueous-electrolyte battery according to the present invention, oxygen deficiency can be generated in the cover layers covering the positive-electrode active-material particles so that the cover layers themselves can have electron conductivity. As a result, the cover layers can have two characteristics of Li-ion conductivity and electron conductivity. In addition, since the entire surfaces of the positive-electrode active-material particles can be covered with the cover layers, formation of high-resistance layers at the contact interfaces between the positive-electrode active-material particles and the sulfide-solid-electrolyte particles is suppressed so that an increase in the interface resistance can be suppressed. As a result of appropriately mixing the covered positive-electrode active-material particles and the solid-electrolyte particles, Li ions and electrons can be stably exchanged through the cover layers in the positive-electrode body.

(7) In a method for producing a positive-electrode body for a nonaqueous-electrolyte battery according to an embodiment of the present invention, in the oxygen-deficiency generation step, the positive-electrode active-material particles covered with the precursor cover layers are heat-treated at 300° C. to 400° C. in a hydrogen-containing atmosphere.

The oxygen-deficiency degree α can be adjusted by changing the temperature of the heat treatment. When this temperature is made 300° C. or more, a dehydration treatment of the films by a sol-gel process can be completed and a desired oxygen deficiency can also be generated. However, when the temperature is made excessively high, interdiffusion may occur between the cover layers and the positive-electrode active-material particles to form low-conductivity layers having a low Li-ion conductivity. Accordingly, when the temperature is made 400° C. or less, the reaction between the cover layers and the positive-electrode active-material particles can be suppressed. In addition, when the temperature is made 400° C. or less, crystallization of the cover layers can be suppressed and the cover layers having Li-ion conductivity and electron conductivity that are sufficient for charge and discharge of the battery can be obtained.

(8) In a method for producing a positive-electrode body for a nonaqueous-electrolyte battery according to an embodiment of the present invention, in the oxygen-deficiency generation step, the positive-electrode active-material particles covered with the precursor cover layers are heat-treated in a hydrogen-containing atmosphere having a hydrogen concentration of 50% by volume or more.

The oxygen-deficiency degree α can also be adjusted by changing the hydrogen concentration. When the hydrogen concentration is made 50% by volume or more, a desired oxygen deficiency can be generated and the cover layers having Li-ion conductivity and electron conductivity that are sufficient for charge and discharge of the battery can be obtained.

(9) In a method for producing a positive-electrode body for a nonaqueous-electrolyte battery according to an embodiment of the present invention, in the mixing step, the covered positive-electrode active-material particles and the sulfide-solid-electrolyte particles are suspended and mixed in an organic solvent.

When the covered positive-electrode active-material particles and the sulfide-solid-electrolyte particles are suspended and mixed in an organic solvent, both particles, in particular, the covered positive-electrode active-material particles are not subjected to high mechanical shock. Accordingly, separation and breakage of the cover layers formed in the covered positive-electrode active-material particles can be suppressed. Thus, since the state where the entire surfaces of the positive-electrode active-material particles are covered with the cover layers can be maintained, formation of high-resistance layers at the contact interfaces between the positive-electrode active-material particles and the solid-electrolyte particles is suppressed so that an increase in the interface resistance can be suppressed.

(10) A nonaqueous-electrolyte battery according to the present invention includes a positive-electrode body, a negative-electrode body, and a solid-electrolyte layer disposed between the electrode bodies, wherein the positive-electrode body is a positive-electrode body for a nonaqueous-electrolyte battery according to the present invention.

Since a nonaqueous-electrolyte battery according to the present invention employs the positive-electrode body for a nonaqueous-electrolyte battery, exchange of Li ions between the positive-electrode active-material particles and the solid-electrolyte particles, exchange of electrons between the positive-electrode active-material particles, and current collection from the positive-electrode active-material particles can be stably achieved through the cover layers. Thus, the output characteristics of the battery can be enhanced.

### Advantageous Effects of Invention

In a positive-electrode body for a nonaqueous-electrolyte battery according to the present invention, cover layers covering the surfaces of positive-electrode active-material particles can have Li-ion conductivity and electron conductivity; even when the entire surfaces of the positive-electrode active-material particles are covered with the cover layers, current collection for the positive-electrode body sufficient for charge and discharge of the battery can be stably ensured. In addition, since the entire surfaces of the positive-electrode active-material particles can be covered with the cover layers, formation of high-resistance layers at the contact interfaces between the positive-electrode active-material particles and the solid-electrolyte particles is suppressed so that an increase in the interface resistance can be suppressed. In a nonaqueous-electrolyte battery employing the positive-electrode body for a nonaqueous-electrolyte battery, exchange of Li ions between the positive-electrode active-material particles and the solid-electrolyte particles, exchange of electrons between the positive-electrode active-material particles, and current collection from the positive-electrode active-material particles can be stably achieved through the cover layers. Thus, the output characteristics of the battery can be enhanced.

### BRIEF DESCRIPTION OF DRAWINGS

FIG. 1 is a schematic view illustrating a positive-electrode body for a nonaqueous-electrolyte battery according to an embodiment.

FIG. 2 is a schematic view illustrating a nonaqueous-electrolyte battery according to an embodiment.

### DESCRIPTION OF EMBODIMENTS

Hereinafter, embodiments according to the present invention will be described on the basis of the drawings. In the drawings, like reference signs denote like elements.

### EMBODIMENTS

### [Overall Configuration]

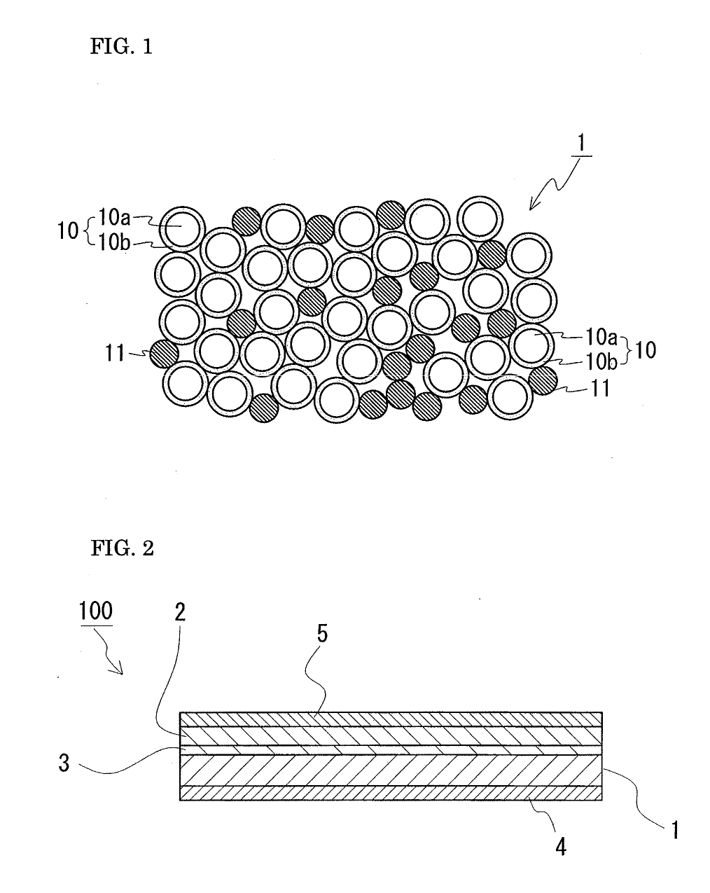

As exemplified in FIG. 2, a nonaqueous-electrolyte battery 100 according to the present invention includes a positive-electrode body 1 for a nonaqueous-electrolyte battery (positive-electrode body 1); a negative-electrode body 2; a solid-electrolyte layer 3 disposed between the electrode bodies; a positive-electrode collector 4 having a current-collecting function for the positive-electrode body 1; and a negative-electrode collector 5 having a current-collecting function for the negative-electrode body 2. The most characteristic feature of the present invention lies in the configuration of the positive-electrode body 1. Hereinafter, the configuration of the positive-electrode body 1 and a method for producing the positive-electrode body 1 according to the present invention will be first described on the basis of FIG. 1; and, subsequently, configurations other than that of the positive-electrode body 1 will be described.

### [Positive-Electrode Body]

The positive-electrode body 1 for a nonaqueous-electrolyte battery according to the present invention includes sulfide-solid-electrolyte particles 11 and covered positive-electrode active-material particles 10 in which the surfaces of positive-electrode active-material particles 10a are covered with cover layers 10b having Li-ion conductivity. The cover layers 10b are formed of an amorphous oxide having oxygen deficiency. The covered positive-electrode active-material particles 10 and the sulfide-solid-electrolyte particles 11 are mixed in a predetermined weight ratio.

### (Covered Positive-Electrode Active-Material Particles)

In the covered positive-electrode active-material particles 10, the surfaces of the positive-electrode active-material particles 10a are covered with the cover layers 10b having Li-ion conductivity. The cover layers 10b are formed of an amorphous oxide having oxygen deficiency and, as a result, the cover layers 10b have electron conductivity. Since the surfaces of the positive-electrode active-material particles 10a are covered with the cover layers 10b, formation of high-resistance layers at the contact interfaces between the positive-electrode active-material particles 10a and the sulfide-solid-electrolyte particles 11 is suppressed so that an increase in the interface resistance can be suppressed.

### <<Positive-Electrode Active-Material Particles>>

The positive-electrode active-material particles 10a may be composed of, for example, a lithium metal oxide such as lithium cobalt oxide (LiCoO₂), lithium nickel oxide (LiNiO₂), lithium manganese oxide (LiMn₂O₄), cobalt- and aluminum-doped lithium nickel oxide (LiNi_{0.8}Co_{0.15}Al_{0.05}O₂), lithium nickel manganese cobalt oxide (LiNi_{0.33}Mn_{0.33}Co_{0.33}O₂), or olivine lithium iron phosphate (LiFePO₄); manganese oxide (MnO₂); sulfur (S); or a sulfide selected from iron sulfide (FeS), iron disulfide (FeS₂), lithium sulfide (Li₂S), and titanium sulfide (TiS₂). Of these, lithium metal oxides, in particular, LiCoO₂ is excellent in electron conductivity and preferred. The positive-electrode active-material particles 10a preferably have an average size of 1 to 10 μm.

### <<Cover Layer>>

The cover layers 10b are formed of an amorphous oxide having oxygen deficiency: for example, lithium niobium oxide (LiNbO_{3-α}), lithium tantalum oxide (LiTaO_{3-α}), or lithium titanium oxide (Li₄Ti₅O_{12-α}). α represents the degree of oxygen deficiency, which considerably influences Li-ion conductivity and electron conductivity. When the cover layers 10b have oxygen deficiency, vacancies for oxygen ions are formed. To maintain electrical neutrality, electrons are introduced into the vacancies. This mobility of electrons probably imparts electron conductivity to the cover layers 10b. There is probably a tendency that an increase in the oxygen-deficiency degree α results in an increase in electron conductivity and a decrease in Li-ion conductivity. In the case of no oxygen deficiency (α=0), the cover layers 10b are Li-ion conductors and substantially do not have electron conductivity. Thus, a needs to be more than 0. When the cover layers 10b have oxygen deficiency, the resultant electron-conductivity value is much larger than the resultant Li-ion-conductivity value. However, excessively large a results in a decrease in the Li-ion conductivity. Accordingly, when α is 0.05 or less, appropriate Li-ion conductivity and electron conductivity can be achieved. When the Li-ion conductivity and the electron conductivity are collectively regarded as electric conductivity, the electric conductivity corresponding to the preferred range of a (0<α≦0.05) is 10⁻⁷ S/cm to 10⁻³ S/cm. The value α remains the same irrespective of the material of the cover layers 10b. To generate oxygen deficiency in the cover layers 10b, a heat treatment described below is performed. When this heat treatment is performed at a high temperature, interdiffusion may occur between the cover layers 10b and the positive-electrode active-material particles 10a to form low-conductivity layers having a low Li-ion conductivity. Accordingly, to suppress the reaction between the cover layers 10b and the positive-electrode active-material particles 10a, the heat treatment needs to be performed at a low temperature and hence the cover layers 10b are in the amorphous state. Since the cover layers 10b are in the amorphous state, a high Li-ion conductivity can be achieved. The above-described materials of the cover layers 10b such as LiNbO_{3-α} and LiTaO_{3-α} a have high a Li-ion conductivity in the amorphous state. The thickness of the cover layers 10b is preferably minimized as long as the formation of high-resistance layers at the contact interfaces between the positive-electrode active-material particles 10a and the sulfide-solid-electrolyte particles 11 can be suppressed, and preferably in the range of 5 nm to 20 nm.

### (Sulfide-Solid-Electrolyte Particles)

The sulfide-solid-electrolyte particles 11 are composed of a sulfide-based solid electrolyte having a high Li-ion conductivity. The sulfide-based solid electrolyte may be based on, for example, Li₂S—P₂S₅, Li₂S—SiS₂, or Li₂S—B₂S₃, and may further contain P₂O₅ or Li₃PO₄. The sulfide-solid-electrolyte particles 11 preferably have an average size of 0.1 to 5 μm.

### [Method for Producing Positive-Electrode Body]

A method for producing an electrode body 1 for a nonaqueous-electrolyte battery according to the present invention includes the following steps:

(a) a covering step of covering the surfaces of the positive-electrode active-material particles 10a with precursor cover layers having Li-ion conductivity;
(b) an oxygen-deficiency generation step of generating oxygen deficiency in the precursor cover layers to form the cover layers 10b; and
(c) a mixing step of mixing the sulfide-solid-electrolyte particles 11 and the covered positive-electrode active-material particles 10 having the cover layers 10b.

### (Covering Step)

The covering step is a step of covering the surfaces of the positive-electrode active-material particles 10a with precursor cover layers having Li-ion conductivity. For example, metal alkoxide (such as equimolar amounts of LiOEt and Nb(OEt)₅) is first dissolved in a solvent (such as ethyl alcohol) to prepare a precursor cover-layer solution. This precursor cover-layer solution is then applied by spray-coating to the positive-electrode active-material particles 10a under ultrasonic vibration so as to cover the entire surfaces of the positive-electrode active-material particles 10a. After the entire surfaces of the positive-electrode active-material particles 10a are completely covered with the precursor cover-layer solution, the solvent is evaporated to form the precursor cover layers. The spray-coating is preferably performed such that the precursor cover layers have a thickness of 5 nm to 20 nm. The process of forming the precursor cover layers is not limited to the above-described process.

### (Oxygen-Deficiency Generation Step)

The oxygen-deficiency generation step is a step of generating oxygen deficiency in the precursor cover layers formed in the covering step, to form the cover layers 10b. For example, the positive-electrode active-material particles 10a having been covered with the precursor cover layers are subjected to a heat treatment at 300° C. to 400° C. in a hydrogen-containing atmosphere having a hydrogen concentration of 50% by volume or more; as a result, oxygen deficiency is generated in the precursor cover layers to form the cover layers 10b. The oxygen-deficiency degree α can be adjusted by changing the hydrogen concentration or the heating temperature. For example, when the positive-electrode active-material particles 10a having been covered with the precursor cover layers are subjected to a heat treatment at 300° C. in a hydrogen-containing atmosphere having a hydrogen concentration of 50% by volume, α becomes 0.01. When the positive-electrode active-material particles 10a having been covered with the precursor cover layers are subjected to a heat treatment at 400° C. in a hydrogen-containing atmosphere having a hydrogen concentration of 100% by volume, α becomes 0.05. There is the following tendency: in the heat treatment, the higher the heating temperature or the higher the hydrogen concentration, the higher the oxygen-deficiency degree α becomes.

### (Mixing Step)

The mixing step is a step of mixing the covered positive-electrode active-material particles 10 having the cover layers 10b formed in the oxygen-deficiency generation step, and the sulfide-solid-electrolyte particles 11. The covered positive-electrode active-material particles 10 and the sulfide-solid-electrolyte particles 11 are preferably mixed in a weight ratio of 50:50 to 80:20. These particles are preferably mixed by a wet process to suppress separation and breakage of the cover layers 10b formed on the surfaces of the positive-electrode active-material particles 10a. Employment of the wet process for the mixing can reduce high mechanical shock on the covered positive-electrode active-material particles 10 and the sulfide-solid-electrolyte particles 11, in particular, on the covered positive-electrode active-material particles 10. For example, the process is performed in the following manner: the covered positive-electrode active-material particles 10 and the sulfide-solid-electrolyte particles 11 are suspended and mixed in an organic solvent (for example, diethyl carbonate) and the organic solvent is then evaporated. When the above-described process is performed, the state where the entire surfaces of the positive-electrode active-material particles 10a are covered with the cover layers 10b can be maintained.

### [Other Configurations]

Hereinafter, configurations other than that of the positive-electrode body 1 for a nonaqueous-electrolyte battery will be described.

### (Positive-Electrode Collector)

The positive-electrode collector 4 is configured to collect current for the positive-electrode body. Examples of the material of the positive-electrode collector 4 include aluminum (Al), nickel (Ni), gold (Au), alloys of the foregoing, and stainless steel.

### (Negative-Electrode Body)

The negative-electrode body 2 contains negative-electrode active-material particles. The negative-electrode active-material particles are composed of, for example, metallic lithium (elemental Li metal), a lithium alloy (alloy containing Li and an additional element), carbon (C) such as graphite, silicon (Si), or indium (In). Of these, the lithium-containing materials, in particular, metallic lithium is preferred because it is advantageous in that a battery having a higher capacity and a higher voltage can be provided. Examples of the additional element in the lithium alloy include aluminum (Al), silicon (Si), tin (Sn), bismuth (Bi), zinc (Zn), and indium (In).

### (Negative-Electrode Collector)

The negative-electrode collector 5 is configured to collect current for the negative-electrode body. Examples of the material of the negative-electrode collector 5 include copper (Cu), nickel (Ni), iron (Fe), chromium (Cr), and alloys of the foregoing. When the negative-electrode body 2 is composed of a material having a high conductivity, the negative-electrode collector 5 may be omitted.

### (Solid-Electrolyte Layer)

The solid-electrolyte layer 3 is composed of a solid electrolyte, preferably, a sulfide-based solid electrolyte having a high Li-ion conductivity. The sulfide solid electrolyte may be based on, for example, Li₂S—P₂S₅, Li₂S—SiS₂, or Li₂S—B₂S₃, and may further contain P₂O₅ or Li₃PO₄. The sulfide solid electrolyte may be the same as the material of the sulfide-solid-electrolyte particles 11 forming the positive-electrode body 1. Alternatively, the solid-electrolyte layer 3 may be composed of an oxide-based solid electrolyte such as LiPON.

### [Operation and Effect]

In the positive-electrode body 1 for a nonaqueous-electrolyte battery, the cover layers 10b have oxygen deficiency and, as a result, the cover layers 10b themselves can have Li-ion conductivity and electron conductivity; even when the entire surfaces of the positive-electrode active-material particles 10a are covered with the cover layers 10b, current collection for the positive-electrode body 1 sufficient for charge and discharge of the battery can be stably ensured. In addition, since the entire surfaces of the positive-electrode active-material particles 10a can be covered with the cover layers 10b, formation of high-resistance layers at the contact interfaces between the positive-electrode active-material particles 10a and the solid-electrolyte particles 11 is suppressed so that an increase in the interface resistance can be suppressed. As a result, exchange of Li ions between the positive-electrode active-material particles 10a and the solid-electrolyte particles 11, exchange of electrons between the positive-electrode active-material particles 10a, and current collection from the positive-electrode active-material particles 10a can be stably achieved through the cover layers 10b.

### TEST EXAMPLES

A positive-electrode body 1 for a nonaqueous-electrolyte battery according to the present invention in FIG. 1 was employed to produce nonaqueous-electrolyte batteries 100. The discharge characteristic of the nonaqueous-electrolyte batteries 100 was evaluated in terms of dependency on current. As COMPARATIVE EXAMPLE, a positive-electrode body for a nonaqueous-electrolyte battery was prepared by mixing sulfide-solid-electrolyte particles 11 and covered positive-electrode active-material particles 10 in which the surfaces of positive-electrode active-material particles 10a are covered with cover layers 10b having no oxygen deficiency; this positive-electrode body was employed to produce a nonaqueous-electrolyte battery 100; the discharge characteristic of the nonaqueous-electrolyte battery 100 was evaluated in terms of dependency on current.

### Example 1

The positive-electrode body 1 was first prepared.

### (1) Covering Step

Equimolar amounts of LiOEt and Nb(OEt)₅ were dissolved in ethyl alcohol to prepare a precursor cover-layer solution. This precursor cover-layer solution was applied to a thickness of 8 nm on the entire surfaces of the positive-electrode active-material particles 10a constituted by a LiCoO₂ powder having an average particle size of 5 μm. At this time, the precursor cover-layer solution was applied by spray-coating to the positive-electrode active-material particles 10a under ultrasonic vibration. Subsequently, ethyl alcohol serving as the solvent was evaporated to form precursor cover layers.

### (2) Oxygen-Deficiency Generation Step

The positive-electrode active-material particles 10a having been covered with the precursor cover layers in the covering step were subjected to a heat treatment at 400° C. in a hydrogen-containing atmosphere having a hydrogen concentration of 100% by volume; as a result, oxygen deficiency was generated in the precursor cover layers to form the cover layers 10b. At this time, the oxygen-deficiency degree α was 0.05 and the electric conductivity was 10⁻³ S/cm. Since the Li-ion conductivity of the cover layers 12b having oxygen deficiency is negligibly small relative to the electron conductivity of the cover layers 12b, the electric-conductivity value probably results from an increase in the electron conductivity.

### (3) Mixing Step

The sulfide-solid-electrolyte particles 11 to be mixed with the positive-electrode active-material particles 10a were prepared by mechanical milling from a raw material that was a powder having an average particle size of 0.5 μm and prepared by mixing Li₂S, P₂S₅, and P₂O₅ in a molar ratio of 70:27:3. The covered positive-electrode active-material particles 10 and the sulfide-solid-electrolyte particles 11 in a weight ratio of 70:30 were suspended and mixed in diethyl carbonate. The diethyl carbonate was evaporated to form the positive-electrode body 1.

The thus-prepared positive-electrode body 1 was then used to produce the nonaqueous-electrolyte battery 100 illustrated in FIG. 2. The positive-electrode body 1 prepared and the solid-electrolyte layer 3 composed of Li₂S—P₂S₅—P₂O₅ were sequentially stacked on a positive-electrode collector 4 constituted by an Al foil. The resultant stack was press-formed at a pressure of 500 MPa in a die having an internal diameter of 10 mm. A negative-electrode body 2 constituted by an In foil was placed on the side opposite to the positive-electrode body 1 with the solid-electrolyte layer 3 therebetween. At this time, the positive-electrode body 1, the solid-electrolyte layer 3, and the negative-electrode body 2 respectively had a thickness of 50 μm, 250 μm, and 500 μm.

The discharge characteristic of the thus-produced nonaqueous-electrolyte battery 100 was evaluated in terms of dependency on current. The battery charged to 4.2 V was discharged at a current of 5 C until the voltage of the battery decreased to 3.0 V. The ratio of the discharge capacity in discharge at 5 C to the charge capacity was determined. Another discharge at a current of 0.1 C was also performed and the ratio of the discharge capacity in discharge at 5 C to the charge capacity was determined. The ratio of the discharge capacity in discharge at 5 C to the discharge capacity in discharge at 0.1 C was evaluated and it was found to be 80%.

### Example 2

The positive-electrode body 1 in EXAMPLE 2 was different from that in EXAMPLE 1 in terms of degree α of oxygen deficiency generated in the cover layers 10b. Hereinafter, this difference will be mainly described and the other configurations, which were similar to those in EXAMPLE 1, will not be described.

The positive-electrode body 1 in this EXAMPLE was different from that in EXAMPLE 1 in terms of conditions for forming oxygen deficiency in the oxygen-deficiency generation step. The positive-electrode active-material particles 10a having been covered with the precursor cover layers in the covering step were subjected to a heat treatment at 300° C. in a hydrogen-containing atmosphere having a hydrogen concentration of 50% by volume; as a result, oxygen deficiency was generated in the precursor cover layers to form the cover layers 10b. At this time, the oxygen-deficiency degree α was 0.01 and the electric conductivity was 10⁻⁵ S/cm. As in EXAMPLE 1, the electric-conductivity value probably resulted from an increase in the electron conductivity.

The discharge characteristic of the nonaqueous-electrolyte battery 100 was evaluated in terms of dependency on current, the nonaqueous-electrolyte battery 100 being produced from the covered positive-electrode active-material particles 10 having the cover layers 10b having oxygen deficiency. The evaluation conditions were as in EXAMPLE 1. The evaluation result was 75%.

### Comparative Example

The positive-electrode body 1 in COMPARATIVE EXAMPLE was different from that in EXAMPLE 1 in that oxygen deficiency was not generated in the cover layers 10b. Hereinafter, this difference will be mainly described and the other configurations, which were similar to those in EXAMPLE 1, will not be described.

Oxygen deficiency was not generated in the cover layers 10b (the oxygen-deficiency generation step was not performed). Accordingly, when the entire surfaces of the positive-electrode active-material particles 10a are covered with the cover layers 10b, since the cover layers 10b do not have electron conductivity, continuity between the positive-electrode active-material particles 10a and current collection from the positive-electrode active-material particles 10a cannot be achieved, and hence the battery cannot function. Accordingly, in the mixing step, the covered positive-electrode active-material particles 10 and the sulfide-solid-electrolyte particles 11 were mixed with a mortar such that mechanical shock was applied to the covered positive-electrode active-material particles 10; as a result, the cover layers 10b were partially separated. The portions from which the cover layers 10b had been separated allowed continuity between the positive-electrode active-material particles 10a and current collection from the positive-electrode active-material particles 10a. At this time, about 70% of the surfaces of the positive-electrode active-material particles 10a were covered with the cover layers 10b.

The discharge characteristic of the nonaqueous-electrolyte battery 100 was evaluated in terms of dependency on current, the nonaqueous-electrolyte battery 100 being produced from the covered positive-electrode active-material particles in which about 70% of the surfaces of the positive-electrode active-material particles 10a were covered with the cover layers 10b having no oxygen deficiency. The evaluation conditions were as in EXAMPLE 1. The evaluation result was 65%.

### [Results]

Compared with COMPARATIVE EXAMPLE, the ratios of the discharge capacity in discharge at 5 C to the discharge capacity in discharge at 0.1 C in EXAMPLES 1 and 2 were respectively high by 15% and 10%.

This is probably because formation of high-resistance layers at the contact interfaces between the positive-electrode active-material particles 10a and the solid-electrolyte particles 11 is suppressed so that an increase in the interface resistance can be suppressed. The cover layers 10b have oxygen deficiency and, as a result, the cover layers 10b themselves can have Li-ion conductivity and electron conductivity. As a result, exchange of Li ions between the positive-electrode active-material particles 10a and the solid-electrolyte particles 11, exchange of electrons between the positive-electrode active-material particles 10a, and current collection from the positive-electrode active-material particles 10a can be probably achieved with stability through the cover layers 10b.

The above-described embodiments can be properly modified without departing from the spirit and scope of the present invention. The scope of the present invention is not limited to the above-described configurations.

### INDUSTRIAL APPLICABILITY

A nonaqueous-electrolyte battery according to the present invention is excellent in the discharge characteristic at a high output, and hence is suitably usable as power supplies of portable devices, such as cellular phones and personal computers, for example.

### REFERENCE SIGNS LIST

1 positive-electrode body for nonaqueous-electrolyte battery (positive-electrode body)
   10 covered positive-electrode active-material particle
      10a positive-electrode active-material particle
      10b cover layer
   11 sulfide-solid-electrolyte particle
2 negative-electrode body
3 solid-electrolyte layer
4 positive-electrode collector
5 negative-electrode collector
100 nonaqueous-electrolyte battery

1: A positive-electrode body for a nonaqueous-electrolyte battery, comprising a mixture of sulfide-solid-electrolyte particles and covered positive-electrode active-material particles in which surfaces of positive-electrode active-material particles are covered with cover layers having Li-ion conductivity, wherein the cover layers are formed of an amorphous oxide having oxygen deficiency.

2: The positive-electrode body for a nonaqueous-electrolyte battery according to claim 1, wherein the amorphous oxide contains Li and at least one element selected from Nb, Ta, and Ti.

3: The positive-electrode body for a nonaqueous-electrolyte battery according to claim 1, wherein degree α of the oxygen deficiency satisfies 0<α≦0.05.

4: The positive-electrode body for a nonaqueous-electrolyte battery according to claim 1, wherein the cover layers have a thickness of 5 nm to 20 nm.

5: The positive-electrode body for a nonaqueous-electrolyte battery according to claim 1, wherein the covered positive-electrode active-material particles and the sulfide-solid-electrolyte particles are mixed in a weight ratio of 50:50 to 80:20.

6: A method for producing a positive-electrode body for a nonaqueous-electrolyte battery, comprising:
a covering step of covering surfaces of positive-electrode active-material particles with precursor cover layers having Li-ion conductivity;
an oxygen-deficiency generation step of generating oxygen deficiency in the precursor cover layers to form cover layers; and
a mixing step of mixing sulfide-solid-electrolyte particles and covered positive-electrode active-material particles having the cover layers.

7: The method for producing a positive-electrode body for a nonaqueous-electrolyte battery according to claim 6, wherein, in the oxygen-deficiency generation step, the positive-electrode active-material particles covered with the precursor cover layers are heat-treated at 300° C. to 400° C. in a hydrogen-containing atmosphere.

8: The method for producing a positive-electrode body for a nonaqueous-electrolyte battery according to claim 6, wherein, in the oxygen-deficiency generation step, the positive-electrode active-material particles covered with the precursor cover layers are heat-treated in a hydrogen-containing atmosphere having a hydrogen concentration of 50% by volume or more.

9: The method for producing a positive-electrode body for a nonaqueous-electrolyte battery according to claim 6, wherein, in the mixing step, the covered positive-electrode active-material particles and the sulfide-solid-electrolyte particles are suspended and mixed in an organic solvent.

10: A nonaqueous-electrolyte battery comprising a positive-electrode body, a negative-electrode body, and a solid-electrolyte layer disposed between the electrode bodies,
wherein the positive-electrode body is the positive-electrode body for a nonaqueous-electrolyte battery according to claim 1.
